(19) United States
(12) Patent Application Publication
(10) Pub. No.: US 2017/0194701 A1
(43) Pub. Date: Jul. 6, 2017

(54) BROADBAND OMNIDIRECTIONAL DIPOLE ANTENNA SYSTEMS

(71) Applicant: Laird Technologies, Inc., Earth City, MO (US)

(72) Inventors: Kok Jiunn Ng, Teluk Intan (MY); Kean Meng Lim, Sungai Petani (MY); Chee Seong Por, Paya Terubong (MY); Tshu Pin Chee, Simpang Ampat (MY)

(21) Appl. No.: 15/062,382

(22) Filed: Mar. 7, 2016

(30) Foreign Application Priority Data
Jan. 4, 2016 (MY) PI2016700003

(51) Int. Cl. H01Q 1/38; H01Q 5/10

(52) U.S. Cl. CPC H01Q 1/38; H01Q 5/10

(57) ABSTRACT

Exemplary embodiments are provided of antennas and antenna systems including the same. In an exemplary embodiment, an antenna generally includes a substrate, a radiating element along the substrate, and a ground element along the substrate. The radiating element includes a high band radiating arm and a low band radiating arm. The antenna may further include one or more resistors for separately controlling peak gain for the high and low bands. Additionally, or alternatively, the antenna may include a ground plane arm along the substrate and a waveguide coplanar transmission line along the substrate for feeding the radiating element. The antenna may comprise a printed circuit board (PCB) dipole antenna. In another exemplary embodiment, an antenna system generally includes first and second PCB dipole antennas. Each PCB dipole antenna may include a high band radiating element or arm and a low band radiating element or arm.

### CROSS-REFERENCE TO RELATED APPLICATION

This application claims the benefit of and priority to Malaysian Patent Application No. PI 2016700003 filed Jan. 4, 2016. The entire disclosure of the above application is incorporated herein by reference.

### FIELD

The present disclosure generally relates to broadband omnidirectional dipole antenna systems or assemblies.

### BACKGROUND

This section provides background information related to the present disclosure which is not necessarily prior art.

Broadband omnidirectional antenna systems are commonly used in various industries. Oftentimes, a broadband omnidirectional antenna will include a printed circuit board (PCB) dipole antenna due to economic factors and costs.

### DRAWINGS

The drawings described herein are for illustrative purposes only of selected embodiments and not all possible implementations, and are not intended to limit the scope of the present disclosure.

FIG. 1 is a perspective view of an antenna system or assembly including two PCB dipole antennas or radiators according to an exemplary embodiment in which the two PCB dipole antennas have oppositely facing orientations with their antenna elements facing in opposite upward and downward directions;

FIG. 2 illustrates a PCB dipole antenna or radiator that may be used in the antenna system shown in FIG. 1, and also illustrating the PCB dipole antenna's high and low band radiating elements, ground plane, ground plane arm, waveguide coplanar transmission line, and four resistors that may be used for separately controlling peak gain for the high and low band according to an exemplary embodiment;

FIG. 3 is a perspective view of an antenna system or assembly including two PCB dipole antennas or radiators as shown in FIG. 2, where both PCB dipole antennas have the same orientation with their antenna elements facing in the same upward direction according to another exemplary embodiment;

FIG. 4 shows a prototype antenna system or assembly including two PCB dipole antennas or radiators as shown in FIG. 2 and ferrite beads that may provide further control of peak gain especially at the low band by reducing the unbalanced current on the cables according to an exemplary embodiment;

FIG. 5 includes exemplary line graphs of voltage standing wave ratio (VSWR) (S11 and S22) and isolation (S21) in decibels (dB) versus frequency measured for the antenna system shown in FIG. 4;

FIG. 6 includes tables of 3D Efficiency, Average Gain, and Max Gain measured at various frequencies from 698 Megahertz (MHZ) to 960 MHz and from 1710 MHz to 2690 MHz for the antenna system shown in FIG. 4; and

FIGS. 7 through 14 illustrates radiation patterns (Azimuth Plane, Phi 0° Plane, and Phi 90° Plane) measured for the antenna system shown in FIG. 4 at frequencies of 698 MHz, 791 MHz, 894 MHz, 960 MHz, 1710 MHz, 1850 MHz, 2500 MHz, and 2690 MHz, respectively.

Corresponding reference numerals indicate corresponding parts throughout the several views of the drawings.

### DETAILED DESCRIPTION

Example embodiments will now be described more fully with reference to the accompanying drawings.

PCB dipole antennas may be used with broadband omnidirectional antenna systems. The inventors hereof have recognized that there are several factors to consider for the PCB dipole antenna. For example, having more than one PCB dipole antenna makes it difficult to maintain the same form factor while also maintaining good performance characteristic. The peak gain of the antennas may also be troublesome as the peak gain may be affected by mutual coupling between the antennas, cable routing, and radiation patterns at certain frequencies that are not in accord to the radiation patterns of a one-half (½ ) wavelength dipole. A conventional attenuation method includes adding cable length, but this will attenuate the high band faster than the low band. Another convention attenuation method is to have an attenuator at the feed, but this attenuates in a relatively flat manner.

Moreover, the inventors hereof have recognized that it is difficult to obtain a wide bandwidth covering the entire Long Term Evolution (LTE) band while also maintaining the omnidirectionality of the antenna system. The inventors have further recognized the difficulties associated with achieving sufficient isolation between antennas within a limited space, providing controlled peak gain to meet regulation certification, controlling the gain at more than one frequency range where the attenuation at a certain frequency is more than the other one, and unbalanced current flow to the cable.

After recognizing the above, the inventors hereof developed and disclose herein exemplary embodiments of antenna systems or assemblies that include multiple antennas or radiators (e.g., two or more PCB antennas, flexible PCB antennas, stamped antennas, plastic plated antennas, etc.). As disclosed herein, an exemplary embodiment of an antenna system may include first and second PCB dipole antennas coupled to (e.g., mounted on, etc.) a base (e.g., dielectric base, plastic base plate, etc.). Each PCB dipole antenna may include high and low band radiating elements, a ground plane, a ground plane arm, and a waveguide coplanar transmission line. Each PCB dipole antenna may also include one or more (e.g., four, etc.) resistors in some exemplary embodiments. The resistors may be used for separately controlling peak gain for the high and low bands. In other exemplary embodiments, the PCB dipole antennas do not include any resistors. The antenna system may be operable with a wide bandwidth across all the LTE band and up to 6 Gigahertz (GHz) in some exemplary embodiments. The antenna system may be configured with controlled peak gain at a reasonable level, whereby peak gain for high band (e.g., from about 1710 MHz to about 2700 MHz, etc.) and low band (e.g., from about 698 MHz to about 960 MHz, etc.) can be controlled separately.

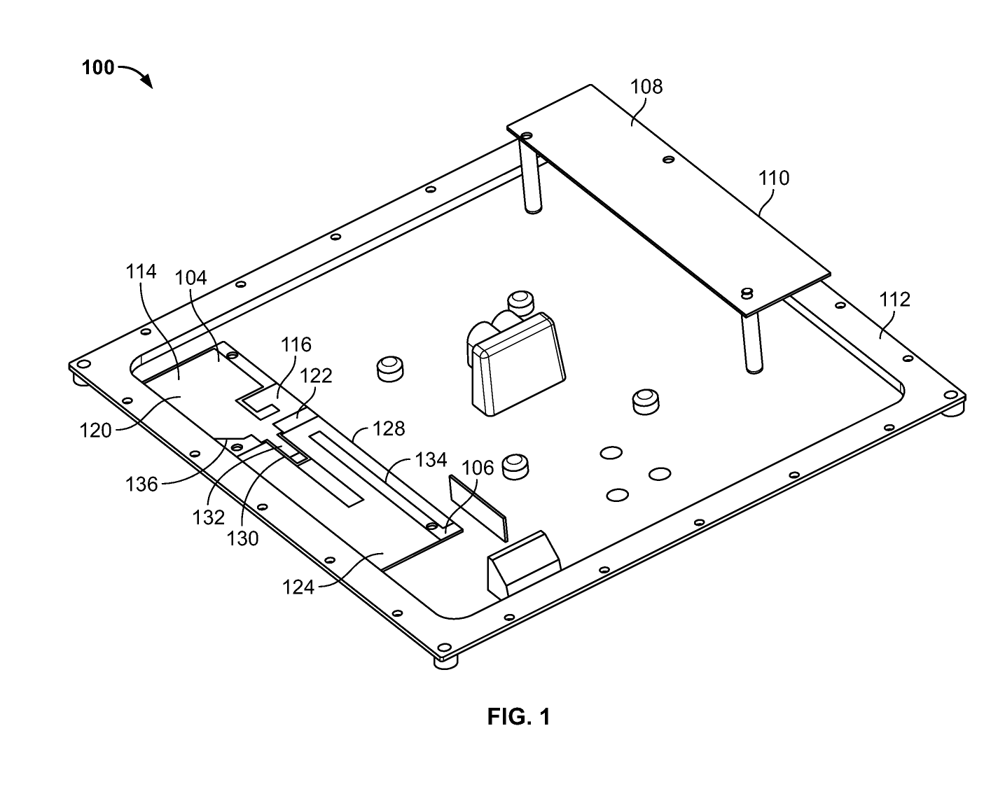

With reference now to the figures, FIG. 1 illustrates an exemplary embodiment of an antenna system or assembly 100 embodying one or more aspects of the present disclosure. As shown, the antenna assembly 100 includes two antennas or radiators 104 and 108 coupled to (e.g., mounted on, etc.) a base 112 (e.g., dielectric base, plastic base plate, etc.).

In this illustrated embodiment, the antennas 104, 108 are PCB dipole antennas that are identical to each other. Each PCB dipole antenna 104, 108 may include a flexible or rigid PCB 106, 110, respectively. Alternatively, the antennas 104, 108 may comprise other types of antennas, and/or may be dissimilar or not identical to each other, and/or may be fabricated via stamping parts, plastic plating methods, constructed from sheet metal by cutting, stamping, etching, etc. For example, other embodiments may include a substrate that may be a rigid insulator, a circuit board substrate (e.g., Flame Retardant 4 or FR4, etc.), a plastic carrier, a flexible insulator, a flexible circuit board, flex-film, etc.

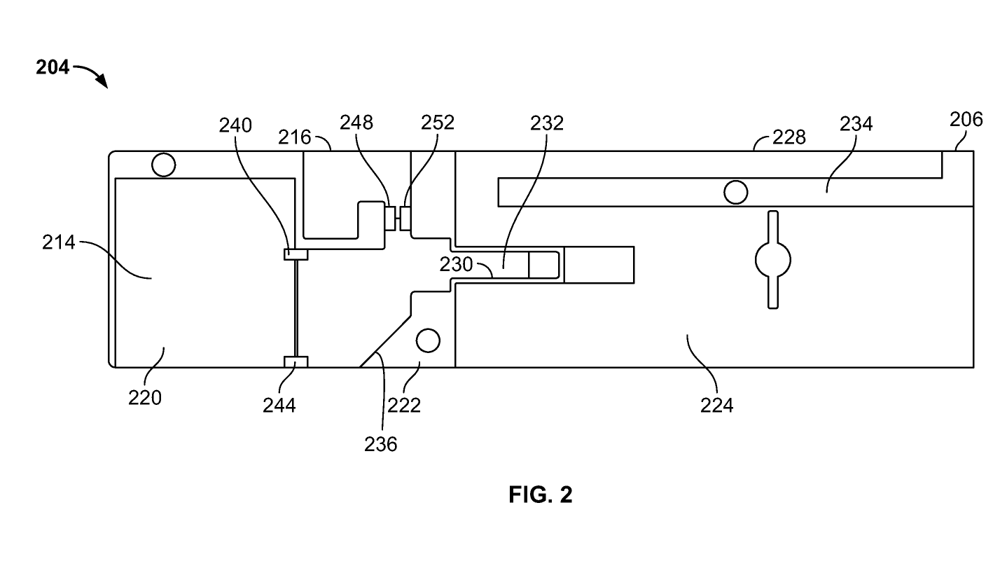

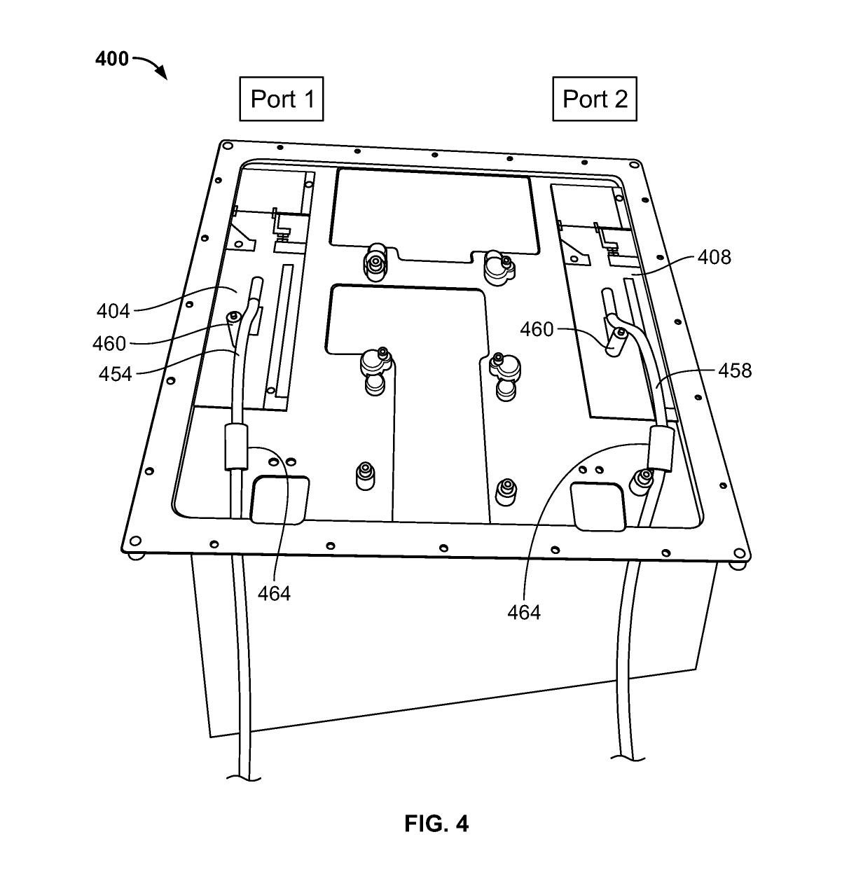

As shown in FIG. 1, the PCB dipole antennas 104, 108 have oppositely facing orientations with their antenna elements facing in respective opposite upward and downward directions. In other words, the second PCB dipole antenna 108 is oriented 180 degrees (e.g., flipped upside down, etc.) as compared to the first PCB dipole antenna 104. Accordingly, the antenna elements of the second PCB dipole antenna 108 are not shown in FIG. 1. But the antenna elements of the second PCB dipole antenna 108 are identical to the corresponding antenna elements of the first PCB dipole antenna 104 in this exemplary embodiment. Alternatively, the first and second dipole antennas 104, 108 may have differently configured antenna elements and/or may have the same orientation with their antenna elements facing in the same direction (e.g., FIGS. 2 and 4, etc.).

With continued reference to FIG. 1, the PCB dipole antenna 104 includes an radiating antenna element 114 that includes a high band radiating element or arm 116 and a low band radiating element or arm 120. The PCB dipole antenna 104 also includes a ground plane or element 124, a ground plane arm 128, and a waveguide coplanar transmission line 132.

The high and low band radiating elements or arms 116, 120 are along an upper or first portion of the PCB 106. The ground plane or element 124 and ground plane arm 128 are along a lower or second portion of the PCB 106. The radiating elements 116, 120 are spaced apart from and separated by a gap or slot 122 from the ground plane element 124. The waveguide coplanar transmission line 132 is disposed at about a middle or third portion of the PCB 106.

The waveguide coplanar transmission line 132 extends or is disposed within a slot 130 defined by the ground element 124. A slot 134 is also defined generally between portions of the ground element 124 and ground plane arm 128. The slots 130, 134 are generally an absence of electrically-conductive material. By way of example, the ground element 124 may be initially formed with the slot 130, or the slot 130 may be formed by removing electrically-conductive material, such as by etching, cutting, stamping, etc. In still yet other embodiments, a slot may be formed by an electrically nonconductive or dielectric material, which is added to the PCB 106 such as by printing, etc.

In this example, the high and low band radiating elements or arms 116, 120, ground plane or element 124, ground plane arm 128, and waveguide coplanar transmission line 132 comprise electrically-conductive traces (e.g., copper, etc.) along the same side of the PCB 106. Accordingly, the PCB dipole antenna 104 may be referred to as a single sided PCB antenna. Alternative embodiments may include one or more double sided PCB antennas.

In some exemplary embodiments, each PCB dipole antenna 104, 108 may also include one or more resistors for separately controlling peak gain for the high and low bands. For example, each PCB dipole antenna 104, 108 may include four resistors having a configuration (e.g., shape, sized, location, resistance, etc.) identical or similar to the four resistors 1, 2, 3, 4 of the PCB dipole antenna 204 described below and shown in FIG. 2. Alternatively, the PCB dipole antennas 104, 108 may include no resistors and/or differently configured resistors in other embodiments.

The first and second radiators 104 and 108 may each be configured with sufficient width to have sufficient bandwidth at the low band for covering frequencies from 698 MHz to 960 MHz. But the inventors recognized that when the width is increased, the radiation patterns tend to be more oval shaped as compared to the radiation patterns of a narrower radiator. Therefore, the optimum width for broadband coverage at the low band is not the optimum width for omnidirectionality. Accordingly, the inventors had to adjust the width in order obtain a sufficient bandwidth while also maintaining the omnidirectionality.

The radiating element 114 generally includes the two radiating elements or arms 116, 120, which may also be respectively referred to herein as high and low band radiating elements or arms. The first and second radiating elements or arms 116, 120 may help to tweak the bandwidth of the low band and the high band. A taper or step 136 is disposed generally between the two arms 116, 120. The taper or step 136 may provide tapering impedance change for wide bandwidth characteristic.

The first and second arms or radiating elements 116, 120 are fed by another step of transmission line, which can be achieved by the waveguide coplanar transmission line 132. The use of the coplanar waveguide transmission line 132 may facilitate soldering, which can be done at the top layer. The transmission line 132 may also provide additional freedom of tweaking the transition of impedance to match the radiating elements 116, 120, which may allow the PCB dipole antenna 104 to be matched up to 6 GHz. Alternatively, other feeding methods may be used, such as a microstrip line instead of the waveguide co-planar transmission line 132.

The ratio of the length of the radiating elements or arms 116, 120 to the length of the ground element 124 may adjusted (e.g., optimized, improved, etc.) to achieve better (e.g., optimum, etc.) omnidirectionality especially the high band. This helps overcome the problem associated with conventional PCB dipole antennas for which the high band radiation pattern tends to squint to one direction due to the asymmetrical structure and the planar shape of the radiator.

With the two PCB dipole antennas 104, 108, the antenna system 100 may thus have MIMO (multiple input multiple output) capability. As shown in FIG. 1, the two PCB dipole antennas 104, 108 may be oriented to face in opposite directions. Alternatively, the first and second dipole antennas 104, 108 may be oriented to face in the same direction as shown in FIGS. 2 and 4.

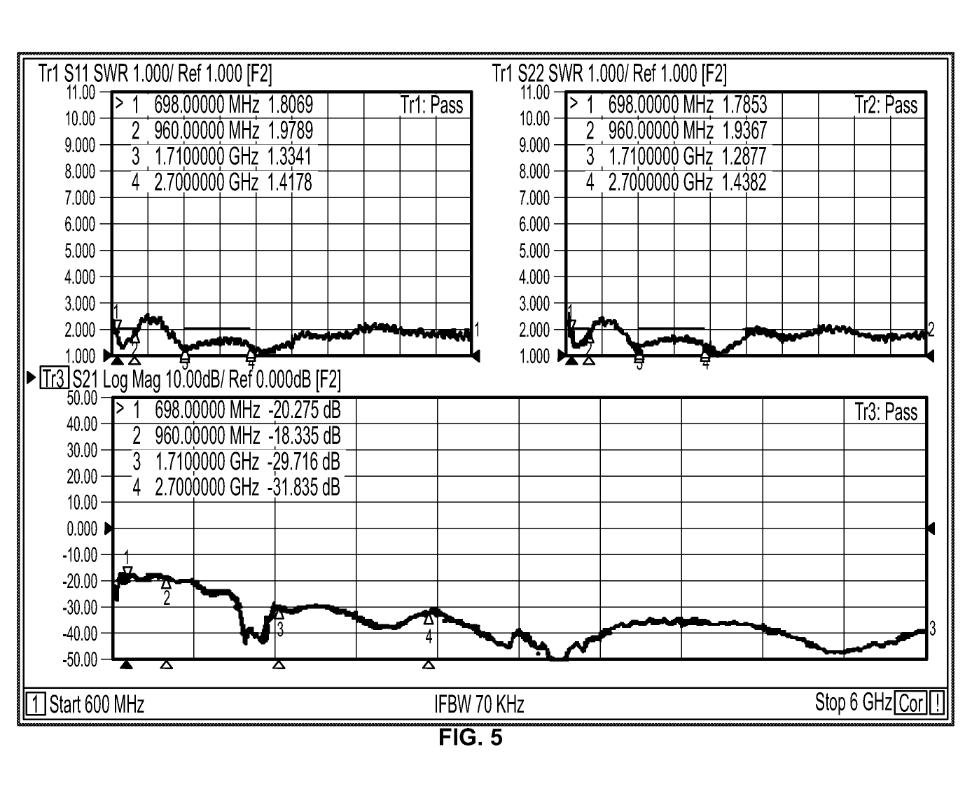

The first and second PCB dipole antennas 104, 108 are spaced apart by a distance to achieve sufficient isolation (e.g., isolation of −15 decibels or better, isolation (S21) as shown in FIG. 5, etc.) between the antennas 104, 108. Conventional radiators with very wide bandwidth may suffer higher coupling.

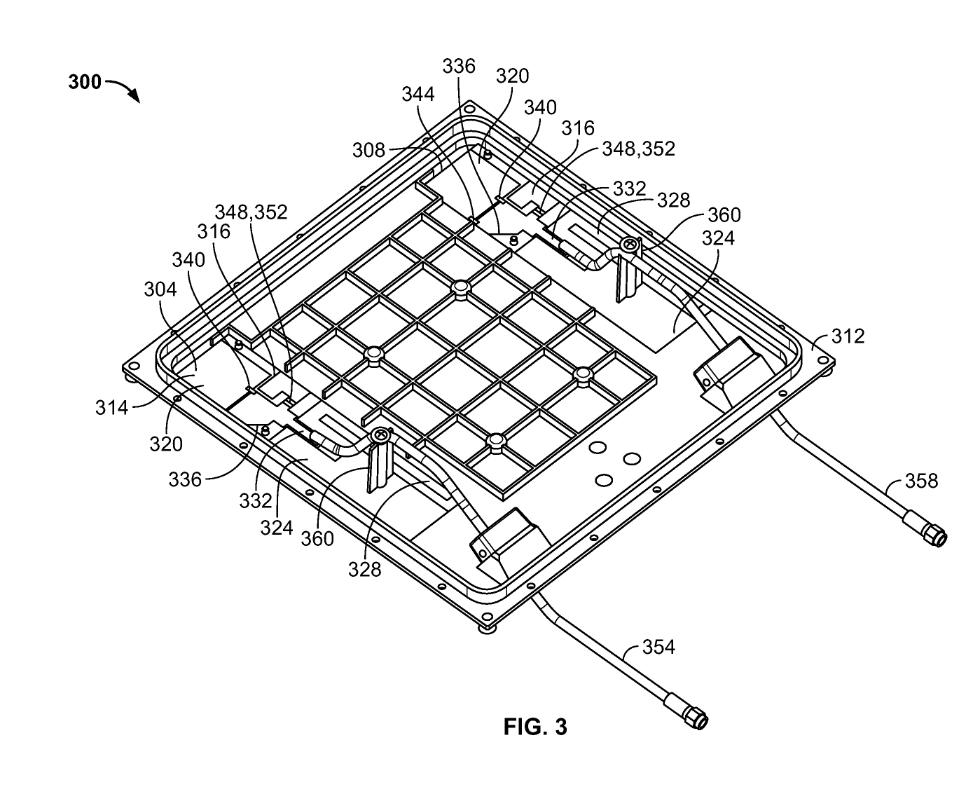

A cable braid of a coaxial cable may be soldered at or along the ground plane 124. The center core of the coaxial may be soldered to the transmission line feeding point. The cable may be bent and routed (e.g., FIG. 3, etc.) to reduce the unbalanced current flow back. Alternatively, other feeding methods may be used besides coaxial cables.

For some applications, a low maximum peak gain in 3D profile may be important. For certain frequency ranges, the antenna system 100 may be unable to meet the low maximum peak gain for such applications. Therefore, the antenna system 100 may include one or more resistors configured not for broad banding the band but to reduce the gain in some embodiments. For example, each dipole antenna 104, 108 may include four resistors as shown in FIG. 2, which may be provided or coupled to (e.g., placed directly on via surface mount technology (SMT), etc.) the high and low band radiating elements or arms of each dipole antenna 104, 108. Alternatively, other exemplary embodiments may include one or more dipole antennas without any resistors, such as when peak gain is not be critical or important.

The location of the resistors may be selected so that the placement of the resistors does not affect the other band of the antenna. This enables the freedom to control the peak gain of the antenna by reducing the particular radiating element's efficiency. For example, two resistors may be located along a portion of the low band radiating element 120 (e.g., at about ⅓ or ½ of the radiating element's length in a direction away from the ground element 124, etc.) to allow the high band element 116 to radiate efficiently and attenuate more only for the low band. And, two resistors may be located along a portion of the high band radiating element 116 (e.g., extending between the high and low band radiating arms 116, 120, etc.). In some exemplary embodiments, one or more resistors may be located farther away from the dividing point between the high and low band radiating elements 116, 120 to a location at which there will be less attenuation at the highband high edge (e.g., about 2700 MHz, etc.) and more attenuation at the highband low edge (e.g., about 1710 MHz, etc.).

FIG. 2 illustrates an exemplary embodiment of a PCB dipole antenna or radiator 204 embodying one or more aspects of the present disclosure. The PCB dipole antenna 204 may be used as the antenna 104 and/or 108 in the antenna system 100 shown in FIG. 1.

The PCB dipole antenna 204 includes features or elements identical or similar to the PCB dipole antennas 104, 108 described above. For example, the PCB dipole antenna 204 includes a radiating antenna element 214 having a high band radiating element or arm 216 and a low band radiating element or arm 220. The PCB dipole antenna 204 also includes a ground plane or element 224, a ground plane arm 228, and a waveguide coplanar transmission line 232. A taper or step 236 is disposed generally between the high band and low band radiating arms 216, 220 of the radiating element 214. The taper or step 236 may provide tapering impedance change for wide bandwidth characteristic.

The PCB dipole antenna 204 include four resistors 240, 244, 248, and 252 for separately controlling peak gain for the high and low bands. The resistors 240, 244, 248, 252 are preferably located such that the first and second resistors 240, 244 have less effect on the high band and such that the third and fourth resistors 248, 252 have less effect on the low band. This enables the freedom to control the peak gain of the PCB dipole antenna 208 by reducing the corresponding high or low band radiating element's efficiency.

In this exemplary embodiment, the first and second resistors 240, 244 are located along the low band radiating element 220 (e.g., at about ⅓ or ½ of the radiating element's length in a direction away from the ground element 224, etc.). This positioning of the first and second resistors 240, 244 allows the high band element 216 to radiate efficiently while the first and second resistors 240, 244 attenuate more only for the low band. The third and fourth resistors 248, 252 are located along the high band radiating element 216 so that the third and fourth resistors 248, 252 will have less impact on the low band. This positioning of the third and fourth resistors 248, 252 allows the low band radiating element 220 to radiate efficiently while the third and fourth resistors 248, 252 attenuate more only for the high band. In some exemplary embodiments, the third and fourth resistors 248, 252 may be located farther away (upward in FIG. 2) from the dividing point between the high and low band radiating elements 216, 220 to a location at which there will be less attenuation at the highband high edge (e.g., about 2700 MHz, etc.) and more attenuation at the highband low edge (e.g., about 1710 MHz, etc.).

By way of example only, the resistors 240, 244, 248, and 252 may comprise SMT thick film resistors. In an exemplary embodiment, the first and second resistors 240, 244 comprise SMT thick film (50R, 1%, 0.66W, 1206) resistors, and the second and third resistors 248, 252 comprise SMT thick film (30R1, 1%, 0.66W, 1206) resistors. Alternatively, Alternatively, other exemplary embodiments may include different resistors having different configurations or no resistors.

The waveguide coplanar transmission line 232 extends or is disposed within a slot 230 defined by the ground element 224. A slot 234 is also defined generally between portions of the ground element 224 and ground plane arm 228. The slots 230, 234 are generally an absence of electrically-conductive material. By way of example, the ground element 224 may be initially formed with the slot 230, or the slot 230 may be formed by removing electrically-conductive material, such as by etching, cutting, stamping, etc. In still yet other embodiments, a slot may be formed by an electrically nonconductive or dielectric material, which is added to the PCB 206 such as by printing, etc.

The PCB dipole antenna 204 may be configured with sufficient width to have sufficient bandwidth at the low band, e.g., from 698 MHz to 960 MHz, etc. But the inventors recognized that when the width is increased, the radiation pattern tends to be more oval shaped as compared to the radiation pattern of a narrower radiator. Therefore, the optimum width for broadband coverage at the low band is not the optimum width for omnidirectionality. Accordingly, the inventors had to adjust the width in order obtain a sufficient bandwidth while also maintaining the omnidirectionality. By way of example only, an exemplary embodiment includes a PCB size of 160 millimeters×38.5 millimeters, which is a balance tradeoff between bandwidth and omnidirectionality for this example as the size may be varied according to the available size of the form factor of the radome.

The first and second arms or radiating elements 216, 220 are fed by a step of transmission line, which can be achieved by the waveguide coplanar transmission line 232. The use of the coplanar waveguide transmission line 232 may facilitate soldering, which can be done at the top layer. The transmission line 232 may also provide additional freedom of tweaking the transition of impedance to match the radiating elements 216, 220, which may allow the PCB dipole antenna 204 to be matched up to 6 GHz. Alternatively, other feeding methods may be used, such as a microstrip line instead of the waveguide co-planar transmission line 232.

The ratio of the length of the radiating elements or arms 216, 220 to the length of the ground element 224 may adjusted (e.g., optimized, improved, etc.) to achieve better (e.g., optimum, etc.) omnidirectionality especially the high band. This helps overcome the problem associated with conventional PCB dipole antennas for which the high band radiation pattern tends to squint to one direction due to the asymmetrical structure and the planar shape of the radiator.

In an exemplary embodiment, the first and second radiating elements or arms 216, 220 may be quarter wavelength (¼ λ) radiating arms. Each arm 216, 220 may be sized to be approximately one quarter of the wavelength of the corresponding resonant frequency. In this embodiment, the first arm 216 is a high frequency radiator and the second arm 220 is a low frequency radiator. Accordingly, the first arm 216 is shorter than the second arm 220. As will be understood by those skilled in the art, although designed to have a primary resonance at some frequency, the first arm 216 will resonate across a first frequency range or high band, and the second arm 220 will resonate across a second frequency range or low band. The first and second frequency ranges each have a bandwidth from the lowest to highest frequency in its frequency range. According to some exemplary embodiments, the first arm 216 is resonant over a frequency range from about 1710 MHz to about 2700 Megahertz, and the second arm 220 is resonant over a frequency range from about 698 MHz to about 960 MHz. In other exemplary embodiments, these frequency ranges may be extended, such as from about 600 MHz to about 960 MHz and from about 1350 MHz to about 6000 MHz depending on the size available and the tradeoff of the omnidirectionality of the radiation pattern versus the VSWR bandwidth.

FIG. 3 illustrates an exemplary embodiment of an antenna system or assembly 300 embodying one or more aspects of the present disclosure. As shown, the antenna assembly 300 includes two antennas or radiators 304 and 308 coupled to (e.g., mounted on, etc.) a base 312 (e.g., dielectric base, plastic base plate, etc.). The antennas 304 and 308 have the same orientation with their antenna elements facing in the same direction, which is upward in FIG. 2.

The antennas 304, 308 are PCB dipole antennas that are identical to each other. Each PCB dipole antenna 304, 308 includes features or elements identical or similar to the PCB dipole antenna 204 described above. For example, and as described above for the PCB dipole antenna 204, each PCB dipole antenna 304, 308 include four resistors 340, 344, 348, and 352 for separately controlling peak gain for the high and low bands. Each PCB dipole antenna 304, 308 also includes a radiating antenna element 314 having a high band radiating element or arm 316 and a low band radiating element or arm 320. Each PCB dipole antennas 304, 304 further includes a ground plane or element 324, a ground plane arm 328, and a waveguide coplanar transmission line 332. A taper or step 336 is disposed generally between the high band and low band radiating arms 316, 320 of the radiating element 314. The taper or step 336 may provide tapering impedance change for wide bandwidth characteristic.

FIG. 3 also shows two coaxial cables 354 and 358 for respectively feeding the first and second PCB dipole antennas 304, 308. The cable braid of each cable 354, 358 may be soldered at or along the ground plane or element 324 of the respective first and second PCB dipole antennas 304, 308. The center core of each coaxial cable may be soldered to the transmission line feeding point of the respective first and second PCB dipole antennas 304, 308. Each coaxial cable 354, 358 may be bent and routed via cable holders 360 to reduce the unbalanced current flow back. For example, as shown in FIG. 3, each coaxial cable 354, 358 bends or routes upwardly to the corresponding cable holder 360 and then bends or routes downwardly for soldering to the corresponding portions of the respective first and second PCB dipole antennas 304, 308. The cable holders 360 hold or suspend portions of the coaxial cables 354, 358 spaced apart above the respective first and second PCB dipole antennas 304, 308.

With the two PCB dipole antennas 304, 308, the antenna system 300 may thus have MIMO (multiple input multiple output) capability. The first and second PCB dipole antennas 304, 308 are spaced apart by a distance to achieve sufficient isolation (e.g., isolation of −15 decibels or better, isolation (S21) as shown in FIG. 5, etc.) between the antennas 304, 308.

FIG. 4 shows a prototype antenna system or assembly 400 embodying one or more aspects of the present disclosure. The antenna system 400 includes features or elements identical or similar to the corresponding features of the antenna system 300. For example, the antenna system 400 includes first and second PCB dipole antennas 404, 408 identical or similar to the first and second PCB dipole antennas 304, 308 of the antenna system 300. The antenna system 400 also includes coaxial cables 454, 458 and cable holders 460 identical or similar to the coaxial cables 354, 358 and cable holders 360 of the antenna system 300.

FIG. 4 also shows ferrite beads 464 along the coaxial cables 454, 458. The ferrite beads 464 may provide further control of peak gain especially at the low band by reducing the unbalanced current on the cables 454, 458. Otherwise, unbalanced current of a cable may have spurious radiation that can cause a spike of peak gain in the 3D radiation pattern.

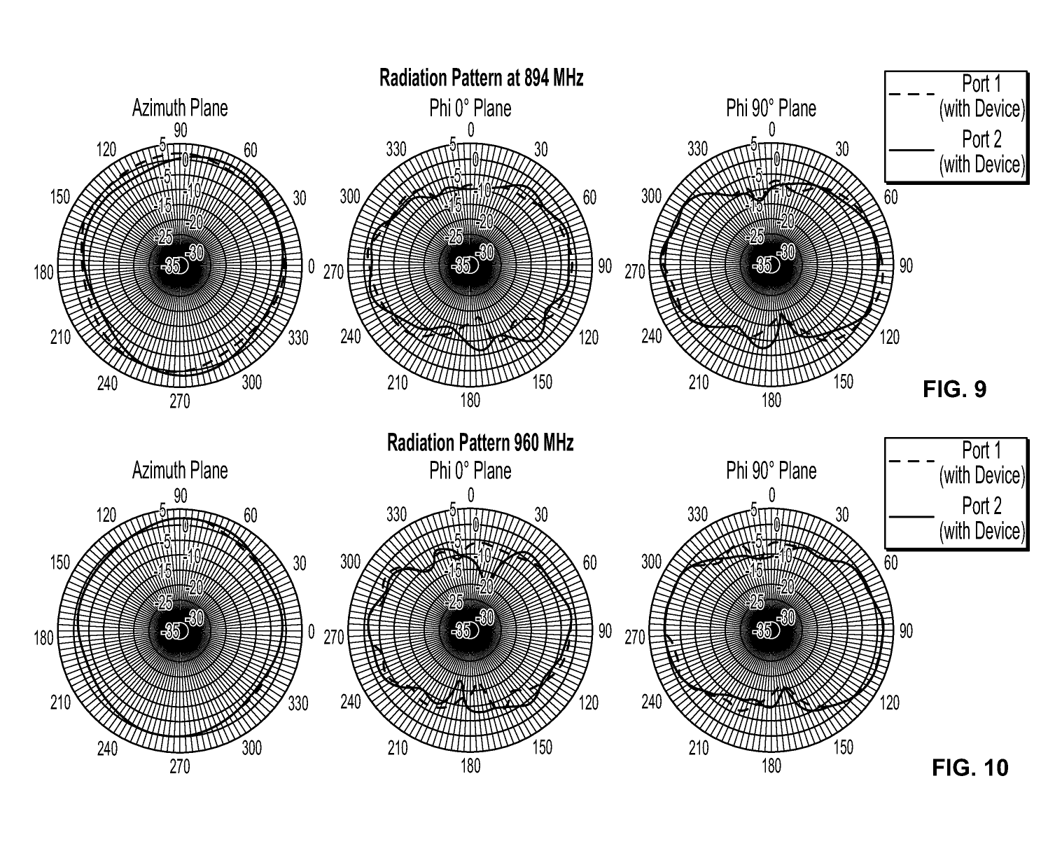

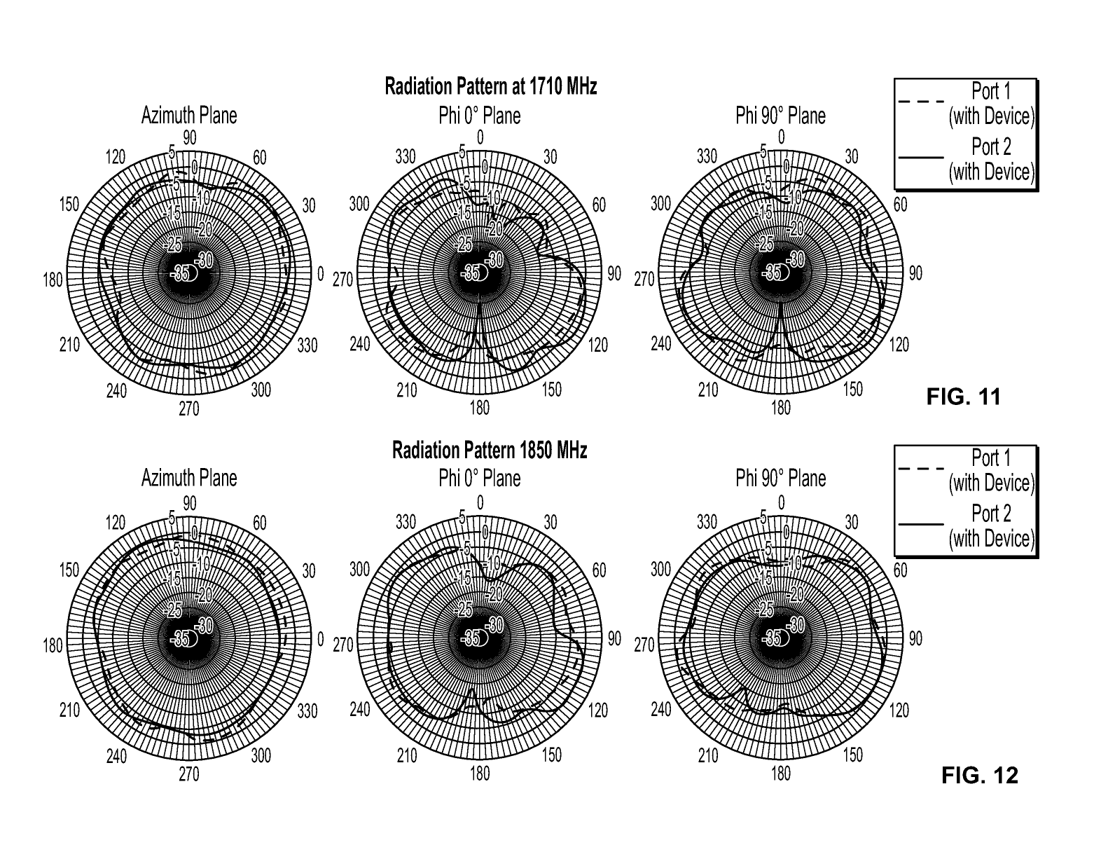

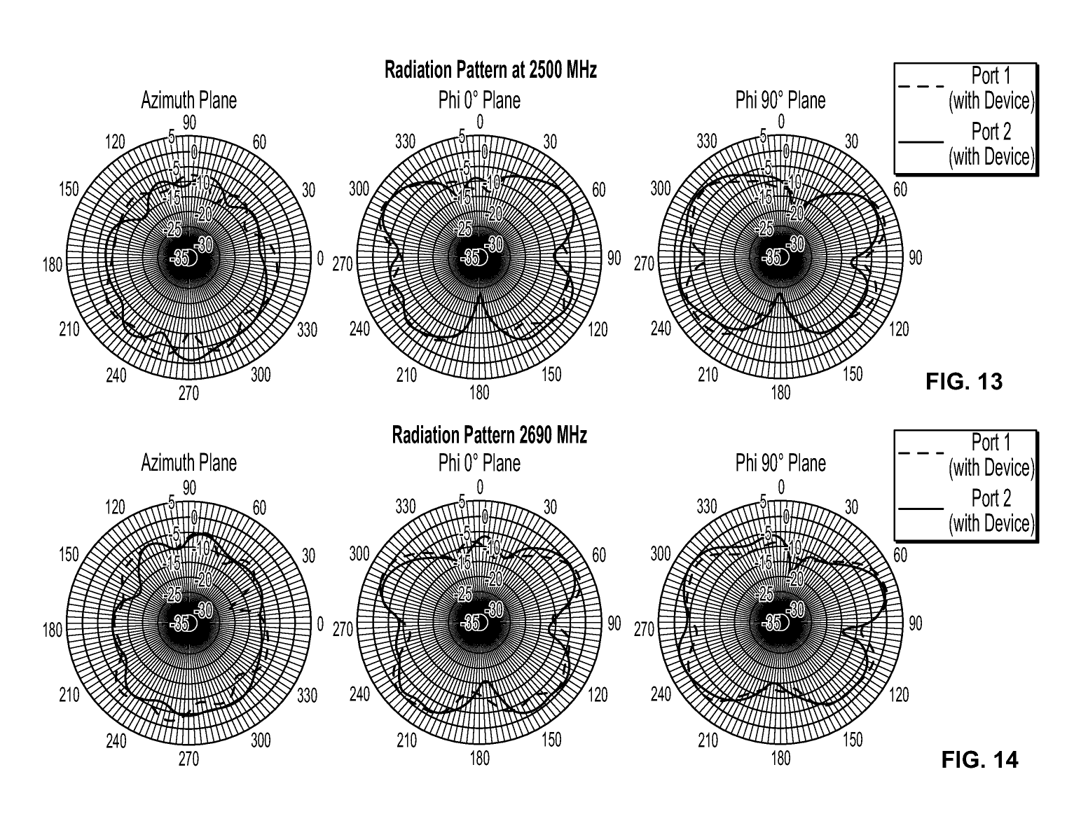

FIGS. 5 through 14 provide results measured for the antenna system or assembly 400 shown in FIG. 4. These results shown in FIGS. 5 through 14 are provided only for purposes of illustration and not for purposes of limitation.

FIG. 5 includes exemplary line graphs of voltage standing wave ratio (VSWR) (S11 and S22) and isolation (S21) in decibels (dB) versus frequency measured for the antenna system or assembly 400 shown in FIG. 4. Generally, FIG. 5 shows that the antenna system 400 is operable with good voltage standing wave ratios (VSWR) and with relatively good isolation between the two PCB dipole antennas 400.

FIG. 6 includes tables of 3D Efficiency, Average Gain, and Max Gain measured at various frequencies from 698 Megahertz (MHZ) to 960 MHz and from 1710 MHz to 2700 MHz for the antenna system shown in FIG. 4. As shown by the tables in FIG. 6, the prototype antenna system 400 shown in FIG. 4 has good efficiency and gain for both the low band from 698 MHz to 960 MHz and the high band from 1710 MHz to 2700 MHz. The antenna systems disclosed herein may also be configured to be functional up to 6 GHz.

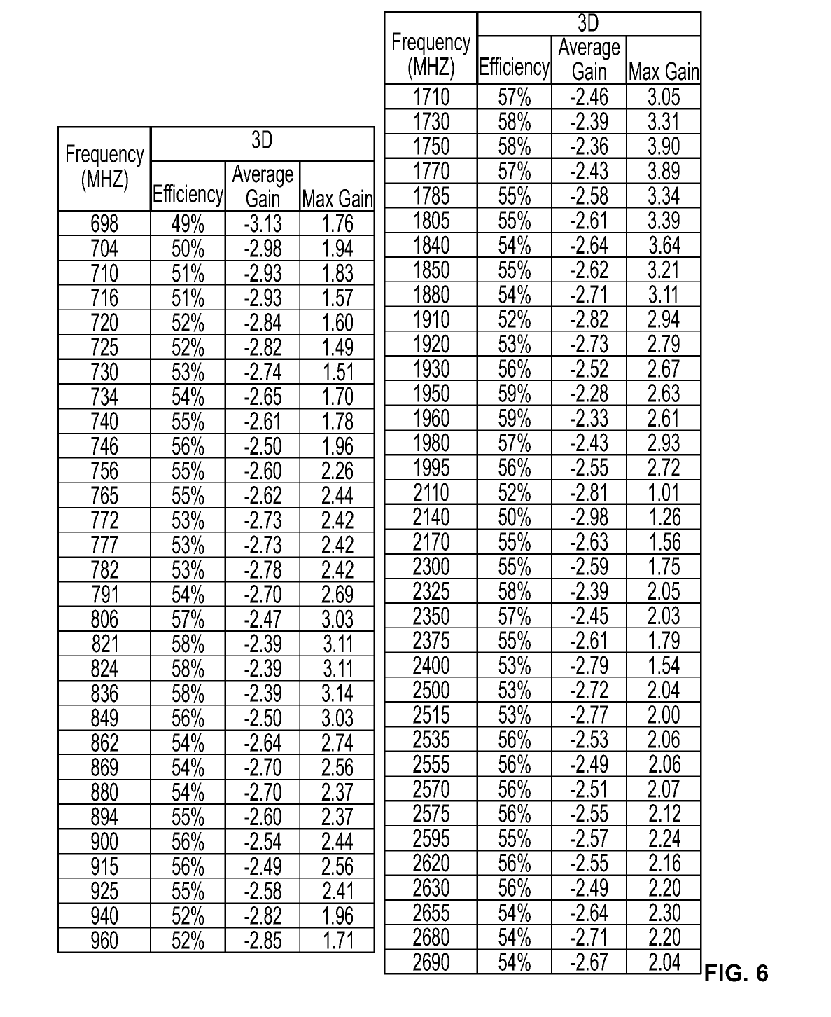

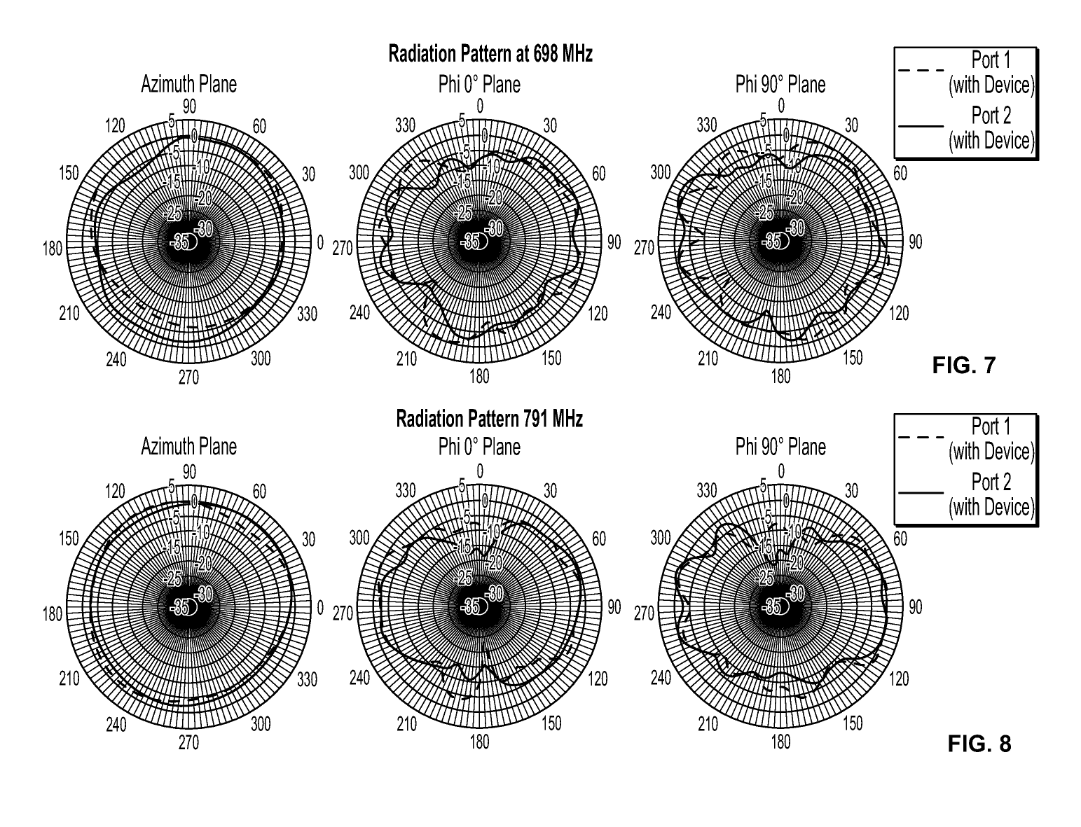

FIGS. 7 through 14 illustrate various measured radiation patterns for the antenna system or assembly 400 shown in FIG. 4. More specifically, FIGS. 7 through 14 illustrate radiation patterns for Port 1 (with Device) and Port 2 (with Device), respectively shown by blue and red lines, for the Azimuth Plane (on the left), the Phi 0° Plane (in the middle), and the Phi 90° Plane (on the right) at frequencies of 698 MHz, 791 MHz, 894 MHz, 960 MHz, 1710 MHz, 1850 MHz, 2500 MHz, and 2690 MHz, respectively. Generally, FIGS. 7 through 14 that the antenna system or assembly 400 shown in FIG. 4 has good omnidirectional radiation patterns at both low band from 698 MHz to 960 MHz and high band from 1710 MHz to 2700 MHz

Although the antenna systems disclosed herein are shown to include two PCB dipole antennas, any number of antennas may be employed without departing from the present disclosure. For example, an antenna system may include one PCB dipole antenna, three PCB dipole antennas, five or more PCB dipole antennas, etc.

Exemplary embodiments of the antenna systems disclosed herein may be suitable for a wide range of applications, such as LTE/4G applications and/or infrastructure antenna systems (e.g., customer premises equipment (CPE), terminal stations, central stations, in-building antenna systems, etc.). An antenna system disclosed herein may be configured for use as an omnidirectional MIMO (multiple input multiple output) or SISO (single input single output) antenna, although aspects of the present disclosure are not limited solely to omnidirectional antennas and/or MIMO or SISO antennas. An antenna system disclosed herein may be implemented inside an electronic device, such as machine to machine (M2M), in-building unit, etc. In which case, the internal antenna components would typically be internal to and covered by an electronic device housing. As another example, the antenna system may instead be housed within a radome, which may have a low profile. In this latter case, the internal antenna components would be housed within and covered by the radome. Accordingly, the antenna systems disclosed herein should not be limited to any one particular end use.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific numerical dimensions and values, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises”, “comprising”, “including”, and “having”, are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second”, and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “outer”, “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An antenna comprising:
a substrate;
a radiating element along the substrate, the radiating element including a high band radiating arm and a low band radiating arm;
a ground element along the substrate; and
one or more resistors for separately controlling peak gain for high band and low band.

2. The antenna of claim 1, wherein:
the substrate comprises a printed circuit board (PCB);
the radiating element and the ground element comprise electrically-conductive traces along the PCB; and
the antenna is a PCB dipole antenna.

3. The antenna of claim 1, wherein:
the low band is from 698 megahertz to about 960 megahertz; and
the high band is from about 1710 megahertz to about 2700 megahertz.

4. The antenna of claim 1, wherein the one or more resistors comprise first, second, third, and fourth resistors located such that the first and second resistors have less effect on the high band and such that the third and fourth resistors have less effect on the low band, whereby the peak gain is controllable by the first, second, third, and fourth resistors reducing efficiency of the corresponding high band radiating arm or low band radiating arm.

5. The antenna of claim 1, wherein the one or more resistors comprise:
first and second resistors along or on a portion of the low band radiating arm;
third and fourth resistors along or one a portion of the high band radiating arm.

6. The antenna of claim 1, wherein the one or more resistors comprise:
first and second resistors along or on a portion of the low band radiating arm that allows the high band radiating arm to radiate efficiently while the first and second resistors attenuate more only for the low band; and
third and fourth resistors along or on a portion of the high band radiating arm that allows the low band radiating arm to radiate efficiently while the third and fourth resistors attenuate more only for the high band.

7. The antenna of claim 1, wherein the one or more resistors comprise one or more thick film resistors provided to the antenna via surface mount technology.

8. The antenna of claim 1, wherein a taper and/or a step is disposed generally between the high band radiating arm and the low band radiating arm, for providing a tapering impedance change for wide bandwidth characteristic.

9. The antenna of claim 1, further comprising:
a ground plane arm along the substrate; and
a waveguide coplanar transmission line along the substrate for feeding the radiating element.

10. The antenna of claim 9, wherein:
the waveguide coplanar transmission line is disposed within a slot defined by the ground element; and
a slot is defined generally between portions of the ground element and the ground plane arm.

11. An antenna system comprising first and second antennas of claim 1.

12. The antenna system of claim 11 wherein:
the first and second antennas have oppositely facing orientations such that the radiating elements of the first and second antennas faces in an opposite directions; or
the first and second antennas have a same orientation such that the radiating elements of the first and second antennas faces in a same direction.

13. The antenna system of claim 11 further comprising:
a first coaxial cable having a cable braid soldered at or along the ground element of the first antenna and a center core soldered to a transmission line feeding point of the first antenna;
a second coaxial cable having a cable braid soldered at or along the ground element of the second antenna and a center core soldered to a transmission line feeding point of the second antenna; and
first and second ferrite beads respectively along the first and second coaxial cables for providing further control of peak gain by reducing unbalanced current on the respective first and second coaxial cables;
wherein the first and second coaxial cables are routed and retained in place by corresponding first and second cable holders to reduce unbalance current flow back.

14. The antenna system of claim 11 wherein:
the antenna system is a broadband omnidirectional dipole antenna system;
the antenna system has MIMO (multiple input multiple output) capability; and
the first and second antennas are coupled to a dielectric base and spaced apart by a distance to achieve sufficient isolation between the first and second antennas.

15. An antenna comprising:
a substrate;
a radiating element along the substrate, the radiating element including a high band radiating arm and a low band radiating arm;
a ground element along the substrate;
a ground plane arm along the substrate; and
a waveguide coplanar transmission line along the substrate for feeding the radiating element.

16. The antenna of claim 15, wherein:
the substrate comprises a printed circuit board (PCB);
the radiating element, the ground element, and the ground plane arm comprise electrically-conductive traces along the PCB; and
the antenna is a PCB dipole antenna.

17. The antenna of claim 15, wherein:
a taper and/or a step is disposed generally between the high band radiating arm and the low band radiating arm, for providing a tapering impedance change for wide bandwidth characteristic; and/or
the low band is from 698 megahertz to about 960 megahertz, and the high band is from about 1710 megahertz to about 2700 megahertz.

18. The antenna of claim 15, wherein:
the waveguide coplanar transmission line is disposed within a slot defined by the ground element; and
a slot is defined generally between portions of the ground element and the ground plane arm.

19. An antenna system comprising first and second antennas of claim 15.

20. The antenna system of claim 19, wherein:
the first and second antennas have oppositely facing orientations such that the radiating elements of the first and second antennas faces in an opposite directions; or
the first and second antennas have a same orientation such that the radiating elements of the first and second antennas faces in a same direction.

21. The antenna system of claim 19, further comprising:
a first coaxial cable having a cable braid soldered at or along the ground element of the first antenna and a center core soldered to a transmission line feeding point of the first antenna;
a second coaxial cable having a cable braid soldered at or along the ground element of the second antenna and a center core soldered to a transmission line feeding point of the second antenna; and
first and second ferrite beads respectively along the first and second coaxial cables for providing further control of peak gain by reducing unbalanced current on the respective first and second coaxial cables;
wherein the first and second coaxial cables are routed and retained in place by corresponding first and second cable holders to reduce unbalance current flow back.

22. The antenna system of claim 19, wherein:
the antenna system is a broadband omnidirectional dipole antenna system;
the antenna system has MIMO (multiple input multiple output) capability; and
the first and second antennas are coupled to a dielectric base and spaced apart by a distance to achieve sufficient isolation between the first and second antennas.
